(19) United States
(12) Patent Application Publication
(10) Pub. No.: US 2009/0102605 A1
(43) Pub. Date: Apr. 23, 2009

(54) Security Arrangement for Security Documents

(75) Inventor: Wittich Kaule, Emmering (DE)

Correspondence Address: GREENLEE WINNER AND SULLIVAN P C, 4875 PEARL EAST CIRCLE, SUITE 200, BOULDER, CO, 80301, US

(73) Assignee: Giesecke & Devrient GMBH, Munchen (DE)

(21) Appl. No.: 11/719,843

(22) PCT Filed: Nov. 15, 2005
(86) PCT No.: PCT/EP05/12221

§ 371 Date: Apr. 3, 2008

(30) Foreign Application Priority Data
Nov. 23, 2004 (DE) 10 2004 056 553.8

(51) Int. Cl. G06K 5/00

(52) U.S. Cl. 340/5.86

(57) ABSTRACT

The present invention relates to a security arrangement (20-1, 20-2) for one of a plurality of homogeneous security documents (10-1, 10-2), having an authenticating feature (22-1, 22-2) that is characteristic for the security document and at least one verification element (24-1, 24-2) for checking the authenticating features (22-1, 22-2) of others of the plurality of homogeneous security documents, in which a damageless check of the authenticating feature (22-1) of a security arrangement (20-1) is practicable exclusively through a predefined combination effect with a verification element (24-2) of a security arrangement (20-2) disposed on another homogeneous security document (10-2).

The present invention relates to a security arrangement for one of a plurality of homogeneous security documents. The present invention further relates to a security document having such a security arrangement, as well as a method for manufacturing one of a plurality of homogeneous security documents.

To increase their counterfeit security, value documents, such as banknotes, stocks, bonds, certificates, vouchers, checks, valuable admission tickets and other papers that are at risk of counterfeiting, such as passports and other identification documents, are normally furnished with security elements that are difficult to counterfeit and whose authenticity or integrity can be visually checked by a user with or without additional auxiliary means.

This kind of protection also includes so-called self-verifying banknotes such as are disclosed in publication WO 98/15418 A1. The self-verifying banknote described there is formed from a flexible sheet composed of a plastic substrate having an identification mark. The sheet exhibits a transparent window area that includes a self-verification means for verifying a security element disposed in a laterally distanced area of the sheet. The self-verification occurs in that the window area is brought into register with the security element by bending or folding the sheet, and the security element and the self-verification means coact there in a suitable manner to confirm the authenticity of the banknote.

Statistical studies have shown that knowledge of the identifying authenticating features of banknotes is little prevalent and present among the population. Presented with a certain specimen of a banknote, the average citizen generally cannot decide whether it is an authentic banknote or merely a good counterfeit. Also with self-verifying banknotes, the user must recognize the self-verifying feature without a comparison option. The average citizen who does not know the effect of the authentic banknote precisely is normally easily tricked by some convincing effect in a counterfeit. Moreover, the security level of a self-verifying banknote is not substantially higher than that of an ordinary banknote, as the verification element is typically also counterfeited together with the security element and simulates for the user an authentic-seeming verification.

Based on that, the object of the present invention is to specify a security arrangement that avoids the disadvantages of the background art. In particular, the security arrangement should combine high counterfeit security with high perception security even by laypeople.

This object is solved by the security arrangement having the features of the main claim. A security document having such a security arrangement and a method for manufacturing one of a plurality of homogeneous security documents are specified in the coordinated claims. Developments of the present invention are the subject of the dependent claims.

According to the present invention, the security arrangement exhibits an authenticating feature that is characteristic for the security document, and at least one verification element for checking the authenticating features of others of the plurality of homogeneous security documents. Here, a damageless check of the authenticating feature of a security arrangement is practicable exclusively through a predefined combination effect with a verification element of a security arrangement disposed on another homogeneous security document, so a self-verification is excluded. Through this measure it is ensured that, for the authenticity check, the user must use a second specimen of the security document, for example a second homogeneous banknote.

In a preferred variant of the present invention, the check of the authenticating feature of a security arrangement occurs in a predefined relative position of the authenticating feature and the verification element. The predefined relative position can be, for example, a stacking of the authenticating feature and the verification element with a certain spacing. This spacing can be given, for example, by the focal distance of a lens or the normal reading distance of a human. The preferred spacing can also be zero, and the authenticating feature and the verification element are then laid on top of one another for checking. Some effects, such as the effect of intersecting polarization foils, can be perceived in a broad spacing interval around the preferred spacing, and others, such as the magnification effect of a lens, are observable only in a narrow range around the preferred spacing.

Advantageously, the authenticating feature and the verification element of the same security arrangement are geometrically so disposed to one another that they are not bringable into the predefined relative position on the security document without damage. Alternatively or additionally, the authenticating feature and the verification element of the same security arrangement can be coordinated with each other in such a way that the authenticating feature and the verification element of the same security arrangement do not display the predefined combination effect in the predefined relative position. In both cases, the self-verification of the security document is effectively prevented and the user is forced to use a second homogeneous document to check the authenticity.

In a second, likewise advantageous variant of the present invention, it is provided that a check of the authenticating feature of a security arrangement occurs through a predefined relative movement of the authenticating feature and the verification element. In this variant, too, the authenticating feature and the verification element of the same security arrangement can be geometrically so disposed to one another that the predefined movement with them is not executable without damage to the security document. Alternatively or additionally, the authenticating feature and the verification element of the same security arrangement can be coordinated with each other in such a way that the authenticating feature and the verification element of the same security arrangement do not display the predefined combination effect upon the predefined relative movement.

The authenticating feature and/or the verification element are preferably designed to be transparent. Here, transparency refers to the complete transparency of a material having a certain gray density, but in contrast to translucency, objects located behind the transparent material remain perceptible.

In an advantageous embodiment, the authenticating feature and the verification element are disposed in or over a shared window area or hole in the security document.

In a further advantageous formation, the authenticating feature and the verification element are disposed in immediate proximity to one another on the security document. In this way can be created particularly easily a geometric arrangement in which a self- verification of the security arrangement is eliminated.

In an expedient embodiment, the verification element comprises an optical imaging element for examining the authenticating features of other security arrangements disposed on homogeneous security documents. The optical imaging element constitutes especially a magnifying lens, such as a Fresnel magnifying lens or a distortion lens. In this way, a microtext imprinted in the authenticating feature, for example, can be made legible, or an optically distortedly imprinted motif brought into the correct form by the associated correction lens.

In another advantageous embodiment, the authenticating feature includes an area printed on with metameric inks. Metameric inks have different reflection spectra, but due to the sensitivity curves of the three color receptors, appear to the human eye in the same tone under ordinary illumination with daylight. However, the underlying difference in the reflection spectra stands out under colored illumination of the metameres or when suitable filters are used. The verification element thus expediently comprises a filter element for viewing the metameric ink area of other security arrangements disposed on homogeneous security documents.

According to a further advantageous embodiment, the authenticating feature comprises a first linearly polarizing window area, and the verification element, a second linearly polarizing window area. Normally, the authenticating feature and/or the verification element comprise yet further polarizing areas. Through the coaction of the different polarization directions when the different areas are brought on top of one another, a range of diverse authenticity checks can be carried out due to the contrast effects occurring.

According to a further preferred embodiment, the authenticating feature and the verification element each comprise a fine line pattern that, when the authenticating feature and the verification element are stacked, produce interference effects, especially moiré effects.

In further embodiments, the authenticating feature and/or the verification element can exhibit a diffraction effect, a lenticular effect, a liquid crystal effect, or a thin film or multi-layer film effect for checking the authenticating feature.

In a development of the present invention, it is provided that the security arrangement includes at least two verification elements for checking the authenticating features of others of the plurality of homogeneous security documents. Here, the check of the authenticating feature occurs under simultaneous use of two or more of the verification elements, which are disposed on one or more of the plurality of homogeneous security documents.

For example, the two verification elements can be disposed at interpupillary distance and formed in the manner of stereoscopic glasses, the authenticating feature of a security arrangement evoking a three-dimensional image impression when viewed with both eyes through the two verification elements of a security arrangement applied on another security document.

In another advantageous embodiment, to check the authenticating feature of a security arrangement, two verification elements and the authenticating feature must be brought on top of one another in a predefined sequence. Here, to exclude a self-verification, it is preferably provided that the bringing on top of one another of the two verification elements of a security arrangement required for the check makes the authenticating feature of the same security arrangement inaccessible. If the two verification elements are brought on top of one another through a certain bending or folding process, then it can be provided, for example, that the authenticating feature is folded together through this bending or folding process and thus becomes accessible. Alternatively, an opaque coating layer that prevents a subsequent verification can automatically be applied to the authenticating feature through this bending or folding process.

In all cited variants of the present invention, in addition to the authenticating feature, also the verification element can be characteristically formed for the security document such that a check of the authenticating feature is practicable only with such security arrangements whose verification element exhibits a characteristic design that is coordinated with the authenticating feature. For example, in a banknote series with different denominations, both the authenticating feature and the verification element can be characteristically formed for each denomination of a banknote such that banknotes of a certain denomination can be verified only with other banknotes of the same denomination.

Alternatively, only the authenticating feature is formed characteristically for the security document, such that a check of the authenticating feature is practicable with any verification element of a security arrangement disposed on another homogeneous security document. For this, in the above-cited example of a banknote series, it can be provided that only the authenticating feature is characteristically formed for the respective denomination of a banknote, but the verification element is homogeneous in all banknotes of the series. Then a banknote of a certain denomination can be verified with any other banknote of the same series regardless of its denomination.

The present invention also comprises a security document, such as a security paper, value document or the like, having a security arrangement of the kind described above. Here, the authenticating feature and the verification element are preferably geometrically so disposed on the security document that they are not bringable into a predefined relative position required for the authenticity check without damage to the security document, or a predefined movement with them is not executable without damage to the security document.

It is advantageous to dispose the authenticating feature and/or the verification element in or over a window area or hole in the security document.

The security document can especially be a security paper or a value document, such as a banknote, a check, an identification card, a certificate or the like.

The present invention further comprises a method for manufacturing one of a plurality of homogeneous security documents, in which the security document is provided with a characteristic authenticating feature and at least one verification element for checking the authenticating features of others of the plurality of homogeneous security documents, a damageless check of the authenticating feature of a security arrangement being able to be carried out exclusively through a predefined combination effect with a verification element of a security arrangement disposed on another homogeneous security document.

Since, with the described security arrangement, the user is forced to use a second specimen of the same for the authenticity check, it combines high counterfeit security with high perception security even by laypeople who have no memory of the effect to be checked. Furthermore, the authenticity check can be carried out simply and reliably by anyone, without additional auxiliary means.

Further exemplary embodiments and advantages of the present invention are explained below by reference to the drawings, in which a depiction to scale and proportion was omitted in order to improve their clarity.

Shown are:

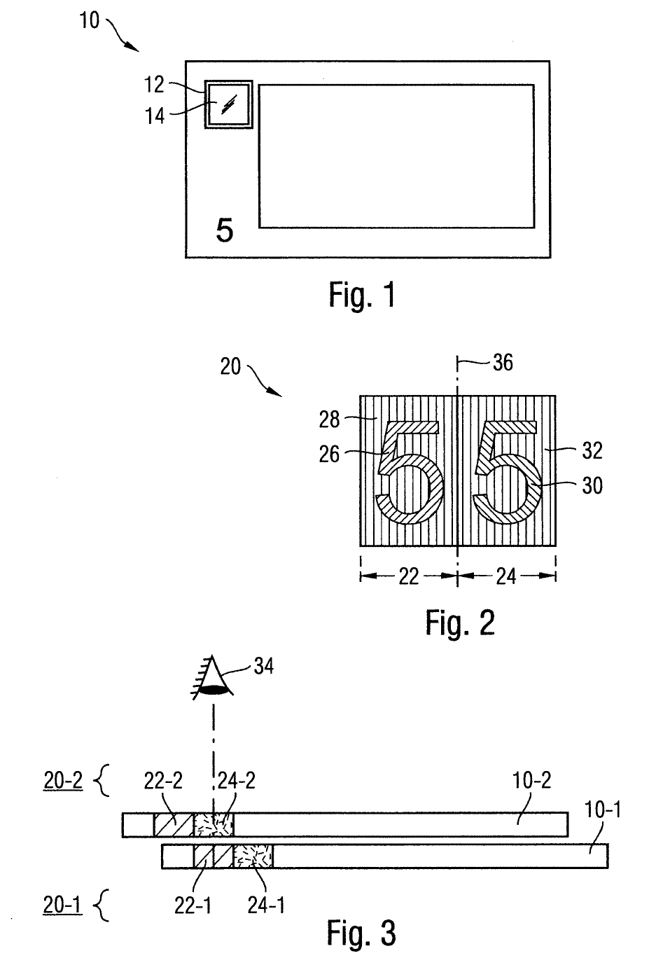

FIG. 1 a schematic diagram of a banknote having, disposed in a transparent window, a security arrangement according to an exemplary embodiment of the present invention,

FIG. 2 a security arrangement according to an exemplary embodiment of the present invention,

FIG. 3 the authenticity check of a banknote furnished with the security arrangement according to FIG. 2, with the aid of a homogeneous banknote,

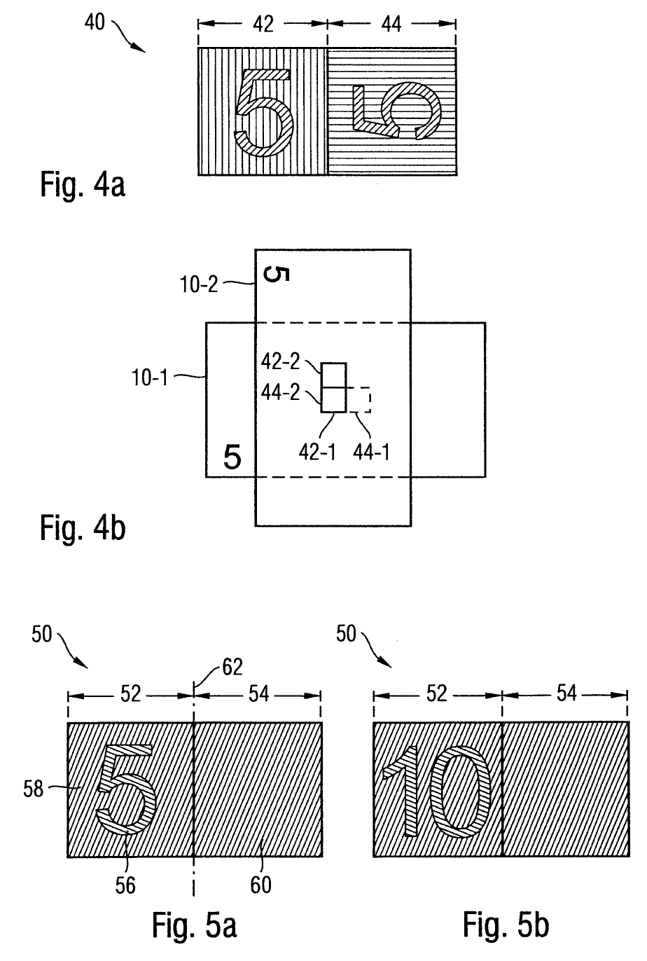

FIG. 4 in (a), a security arrangement according to another exemplary embodiment of the present invention, and in (b), the authenticity check of a banknote provided with the security arrangement in (a), with the aid of a homogeneous banknote,

FIG. 5 in (a) and (b), security arrangements according to a further exemplary embodiment of the present invention that facilitate an external verification within the same banknote series,

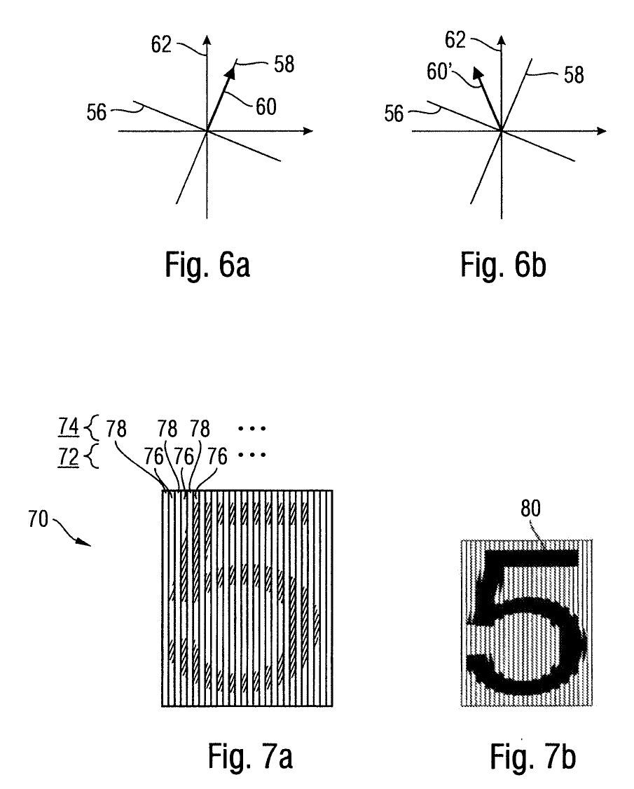

FIG. 6 in (a), a diagram that shows the polarization directions of the areas involved in the external verification of a banknote, and in (b), a diagram that shows corresponding polarization directions in an attempted self-verification,

FIG. 7 in (a), a security arrangement according to a further exemplary embodiment of the present invention, and in (b), the complete image in the authenticity check,

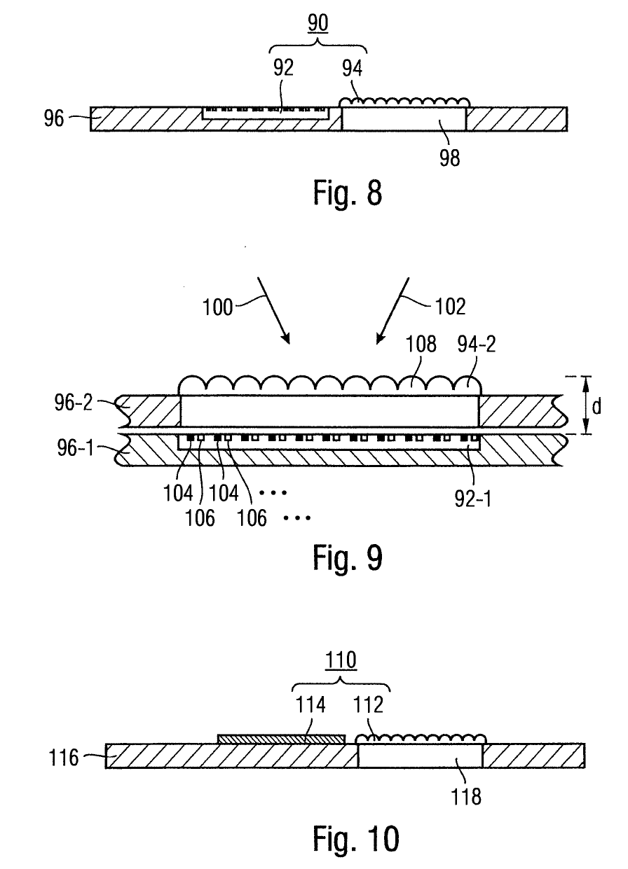

FIG. 8 a banknote having a security arrangement according to a further exemplary embodiment of the present invention, in cross section,

FIG. 9 in detailed depiction, two banknotes of the kind shown in FIG. 8, stacked for the authenticity check,

FIG. 10 a banknote having a security arrangement according to yet a further exemplary embodiment of the present invention, in cross section,

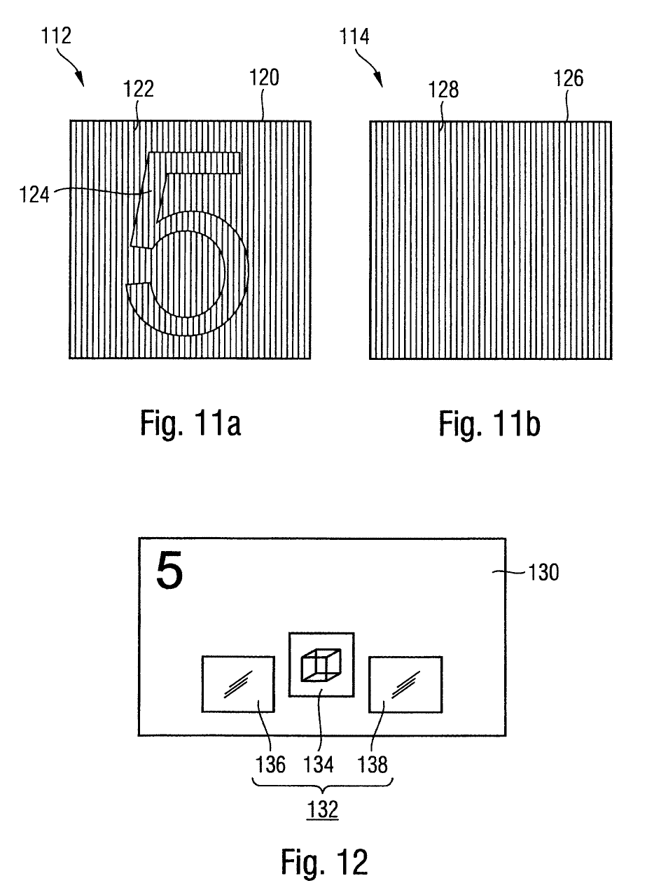

FIG. 11 a more precise depiction of the authenticating feature (a) and of the verification element (b) of the security arrangement in FIG. 10,

FIG. 12 a banknote having a security arrangement having two verification elements according to an exemplary embodiment of the present invention, as viewed from above,

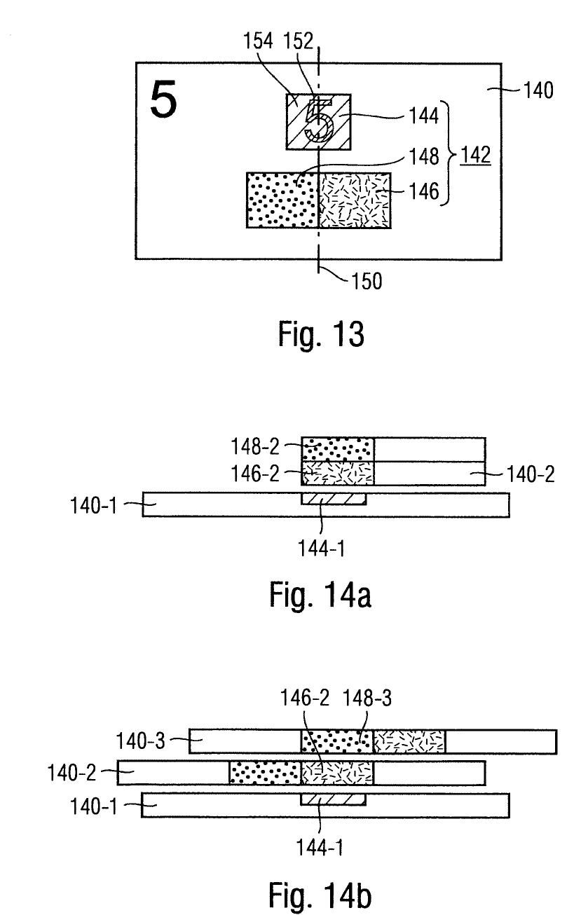

FIG. 13 a banknote having a security arrangement having two verification elements according to another exemplary embodiment of the present invention, as viewed from above, and

FIG. 14 in (a) and (b), two variants for checking the authenticity banknote furnished with the security arrangement in FIG. 13.

The invention will be explained below using a banknote as an example. FIG. 1 shows a schematic diagram of a banknote 10 that is furnished, in a transparent window 12, with a security arrangement 14 according to an exemplary embodiment of the present invention. As explained in detail below, the window area 12 appears patternless when viewed normally. Only when a second, homogeneous banknote is used and the two banknotes are brought into a predefined relative position does a characteristic feature appear in the window area, such as a predefined graphic motif or the denomination of the banknote.

FIG. 2 shows a first exemplary embodiment of such a security arrangement 20. The security arrangement 20 exhibits an authenticating feature 22 and a verification element 24 that are disposed immediately next to each other in the window area 12 of the banknote 10. The authenticating feature 22 includes a first linearly polarizing area 26 in the form of the numeral “5”, having, in the exemplary embodiment, a first polarization direction of +45° with respect to the centerline 36 of the security arrangement 20. A second linearly polarizing area 28 surrounds the first area 26 and exhibits a second polarization direction of 0° in the exemplary embodiment. The contour line surrounding the first linearly polarizing area 26 is added in the figure merely to depict the two areas more clearly.

The verification element 24 of the security arrangement 20 includes a third linearly polarizing area 30 of the same form and size as the first area 26 of the authenticating feature 22, as well as a fourth linearly polarizing area 32 surrounding the third area. The polarization direction of the third area 30 is vertical to the polarization direction of the first area 26, while the polarization direction of the fourth area 32 lies parallel to the polarization direction of the second area 26. The four polarization areas 26-32 all exhibit the same gray density.

Since the human eye is not sensitive to the polarization direction of light, under normal illumination conditions, the four areas 26-32 of the security arrangement 20 evoke in the viewer the impression of a patternless, translucent, gray surface.

Now, if, as shown in FIG. 3, two homogeneous banknotes 10-1 and 10-2 having security arrangements 20-1 and 20-2 are stacked such that the verification element 24-2 of the second banknote 10-2 comes to lie over the authenticating feature 22-1 of the first banknote 10-1, then the numeral “5” stands out clearly for the viewer 34 due to the intersecting polarization directions of the two stacked, linearly polarizing areas 26 and 30. The appearance of the correct denomination when a further homogeneous banknote is laid on top can be assessed by the user as proof of the authenticity of the banknote 10-1 to be checked.

Conversely, of course, the banknote 10-1 can also be used to check the authenticity of the banknote 10-2, such that the two banknotes can verify each other reciprocally. Such a reciprocal verification leads to an increased level of security compared with self-verifying banknotes, since in self-verifying banknotes, in addition to the authenticating feature, also the verification element can be counterfeited. Thus, in reciprocal verification, the authenticity check is done with two banknotes. The user usually already has one of them in his possession and uses it to verify a newly accepted one, such as change from a cashier. The probability that the banknote already present and the newly accepted banknote are counterfeited in the same manner and that verification thus occurs with two counterfeited banknotes is practically negligible.

A self-verification of the banknote 10, in other words the use of the verification element 24 to check the authenticating feature 22 of the same banknote, is, according to the present invention, not possible without damage to the note.

In the exemplary embodiment, this is ensured through the choice of the polarization directions of the different linearly polarizing areas and the lack of mirror symmetry in the encoded numeral “5”. By folding the banknote 10 about the centerline 36 of the security arrangement 20, the verification element 24 and the authenticating feature 22 are indeed brought on top of one another, but then the numeral areas formed by the areas 26 and 30 are not congruent, but rather are oriented mirror reversed to one another.

Furthermore, upon folding, the polarization direction of one of the two linearly polarizing areas 26 and 30 is mirrored at the centerline 36 and thus rotated 90°, such that, after folding, the areas 26 and 30 exhibit the same polarization direction. Thus, even in its overlap area, no additional weakening of the light passing through occurs due to intersecting polarizations, such that the encoded information cannot be recognized due to the lack of a difference in contrast to the surroundings 28, 32.

In an alternative embodiment, the security arrangement 20 is formed in the window area with such high stiffness that it cannot be damagelessly folded about its centerline 36. It is also possible to dispose the authenticating feature and the verification element at the given stiffness so small and with such small spacing that, due to the minimal curvature radius, they cannot be laid on top of one another when folded. In both cases, the authenticating feature 22 and the verification element 24 of the same note cannot physically be brought on top of one another.

A further possibility to exclude the self-verification of an externally verifiable security arrangement 40 is illustrated in FIGS. 4(a) and (b). In the security arrangement 40 in FIG. 4(a), except for the quadratic shape, the authenticating feature 42 and the verification element 44 are formed principally as in FIG. 2. However, in contrast to the embodiment there, the authenticating feature 42 and the verification element 44 are not only disposed immediately next to each other, but are additionally twisted 900 toward each other. This makes it impossible to lay the verification element 44 in the correct orientation on the authenticating feature 42 of the same banknote without destroying the banknote.

However, if two homogeneous banknotes 10-1 and 10-2 having authenticating features 42-1 and 42-2 and verification elements 44-1 and 44-2 are available, then, to check the authenticity, the second banknote 10-2 is laid, twisted by 90°, on the first banknote 10-1, as shown in FIG. 4(b). In this way, the numeral areas of the verification element 44-2 of the second banknote 10-2 and of the authenticating feature 42-1 of the first banknote 10-1 come to lie on top of one another in the same orientation, and the encoded information can be read as described above.

The security arrangements 50 shown in the exemplary embodiment in FIG. 5 not only permit an external verification with the aid of a second banknote of the same denomination, but also facilitate verification through banknotes of another denomination within a banknote series. As examples of this, security arrangements 50 for banknotes having two different denominations (“5” and “10”) are shown in FIGS. 5(a) and (b).

The security arrangement 50 in FIG. 5(a) includes an authenticating feature 52 and a verification element 54 disposed immediately next to each other. The authenticating feature 52 exhibits a first linearly polarizing area 56 in the form of the numeral “5” having a first polarization direction of −67.5° with respect to the centerline 62 of the security arrangement, which is surrounded by a second linearly polarizing area 58 having a second polarization direction of +22.5°. When viewed in unpolarized light, the two linearly polarizing areas 56 and 58 exhibit the same gray density, such that the encoded numeral “5” is not perceptible under ordinary viewing conditions. The verification element 54 of the security arrangement 50 includes a third linearly polarizing area 60 whose polarization direction corresponds to the polarization direction of the second area 58, so is +22.5°.

The security arrangement 50 in FIG. 5(b) for a banknote of another denomination is, with the exception of the shape of the first linearly polarizing area 56, which in this case forms the numeric string “10”, composed identically to the security arrangement 50 in FIG. 5(a).

If two banknotes of this banknote series having any denomination are now stacked such that the verification element 54 of the top banknote lies over the authenticating feature 52 of the bottom banknote, a relative position of the polarization directions involved results, as depicted in FIG. 6(a).

The polarization direction of the third area 60, which functions as an analyzer, and the polarization direction of the second area 58 are oriented parallel and are thus translucent, while the polarization directions of the analyzer 60 and of the first area 56 stand vertically on top of one another and thus transmit no light. Thus, in transmitted light, the numeral or numeric string of the banknote lying on bottom stands out in clear contrast, black against a gray background.

Here, the numeral “5”, for example, appears when the verification element 54 in FIG. 5(b) is laid on top of the authenticating feature 52 in FIG. 5(a), and the numeric string “10” when, conversely, the verification element 54 in FIG. 5(a) is laid on top of the authenticating feature 52 in FIG. 5(b). Analogous results are obtained for the further denominations of the banknote series.

Due to the chosen polarization directions, a self-verification of the security arrangements 50 through folding of the arrangements about the centerline 62 is not possible. If, namely, the verification element 54 in FIG. 5(a) is folded onto the associated authenticating feature 52, then the polarization direction of the third linearly polarizing area 60 is reflected at the centerline 62 and, after folding, now measures −22.5°, as illustrated by the arrow 60′ indicating the polarization direction of the folded third area in FIG. 6(b). The polarization directions of the first and second linearly polarizing area 56 or 58 then each enclose the same angle (45°) with the polarization direction of the folded third area 60′ such that unpolarized light is attenuated equally strongly in each case by the combination of the first area 56 and the folded third area 60′ and the combination of the second area 58 and the folded third area 60′. The first and second area 56 and 58 thus exhibit no contrast difference when viewed, and the encoded numeral or numeric strings of the authenticating feature 52 cannot be perceived.

In the further exemplary embodiment in FIG. 7(a), the authenticating feature 72 and the verification element 74 of the security arrangement 70 are each broken down into a plurality of alternatingly disposed strips 76 and 78 of the same width. Here, the encoded information, here the numeral “5” again for illustration, is substantially distributed across all strips 76 of the authenticating feature 72.

In addition to the breakdown into strips, for encoding, the authenticating feature 72 and the verification element 74 can again exhibit linearly polarizing sub-areas having different polarization directions, as described above. In any case, the security arrangement 70 is designed such that the numeral or numeric string of the authenticating feature 72 is not perceptible under ordinary viewing conditions, but rather stands out only in coaction with the verification element 74.

To check the authenticity of a banknote provided with the security arrangement 70, a further banknote of the same denomination is absolutely mandatory. If the two banknotes are stacked offset by the width of a strip, then a strip 76 of the authenticating feature 72 of one banknote and a strip 78 of the verification element 74 of the other banknote each lie on top of one another such that the encoded information becomes visible. For example, in the security arrangement shown in FIG. 7(a), after two banknotes are stacked, the appearance 80 shown in FIG. 7(b) results. It is understood that even clearer contours of the complete image 80 can be obtained through a finer breakdown of the authenticating feature and the verification element into strips, or through a numeral design that is adapted to the form of the strips.

FIG. 8 shows a further exemplary embodiment of the present invention, in which the security arrangement 90 comprises an authenticating feature 92 that is introduced into a surface layer on the front of a banknote 96, as well as, applied a short distance therefrom and comprising a lenticular array of parallel cylinder lenses, a verification element 94 that is applied over a window area or hole 98 in the banknote 96. The authenticating feature 92 and the verification element 94 are affixed near the center of the banknote 96 such that they cannot be brought on top of one another by rolling the banknote into a cylinder.

In the exemplary embodiment shown, the authenticating feature 92 includes a latent tilt image that is characteristic for the banknote and that can be depicted with a lenticular array in the manner of the verification element 94. The security arrangement 90 is designed for external verification with banknotes of different denominations in the same series, as explained in greater detail with reference to the detailed depiction in FIG. 9.

FIG. 9 shows two banknotes 96-1 and 96-2 that are stacked such that the verification element 94-2 of the top banknote 96-2 lies on the authenticating feature 92-1 of the bottom banknote. In the figure, for the sake of clarity, the two banknotes are depicted with a small gap.

The authenticating feature 92-1 includes a latent tilt image that is characteristic for the banknote 96-1 and that is capable of depicting, for example, from a first viewing direction 100, the denomination of the banknote, and from a second viewing direction 102, a graphic motif. The lenticular array 108 of the verification element 94-2 is formed identically in all banknotes of the banknote series such that each banknote in the series can be used equally for external verification. In the position shown in FIG. 9 for the banknotes 96-1 and 96-2, the lenticular array 108 exhibits a distance d from the tilt image of the authenticating feature 92-1, which distance is given substantially by the thickness of the banknote paper.

The image information 104, 106 of the two motifs of the tilt image are alternatingly inscribed in a laser-sensitive recording layer of the banknote 96-1, for example with a pulsed infrared laser, or are suitably imprinted on the banknote paper with methods known to those of ordinary skill in the art. The sequence of the image information 104, 106 is so coordinated with the focusing effect of the lenticular array 108 and the spacing d for the authenticity check that, from the first viewing direction 100, in each case, only the image information 104 of the first motif and, from the second viewing direction 102, only the image information 106 of the second motif are visible.

Without the lenticular array 108 of the second banknote 96-2 being laid on it, the authenticating feature 92-1 displays merely a confusing pattern in which the image information 104, 106 of the two inscribed motifs are blended. Only when an adapted lenticular array is laid on does a tilt image result that displays different motifs from different viewing directions. Accordingly, alone, the image pattern 104, 106 of the authenticating feature is referred to as a “latent tilt image”.

The appearance of the tilt image when the second note 96-2 is laid on offers the viewer the guarantee of the authenticity of the banknote 96-1 to be checked. Conversely, the banknote 96-1 with its verification element can also be used to verify the banknote 96-2.

According to the present invention, a self-verification of a banknote 96 is not possible, since for one thing, the authenticating feature 92 and the verification element 94 cannot be brought on top of one another by rolling the banknote. Also a folding of the banknote 96 along the centerline of the two elements does not lead to a depiction of the tilt image since, depending on the folding direction, either the lenticular array of the verification element 94 comes to lie upside down on the authenticating feature 92 such that the cylinder lenses cannot exhibit their focusing effect, or the spacing between the image information 104, 106 and the lenticular array measures twice the design spacing d such that, due to the cylinder lenses, the image information 104, 106 is not distributed correctly to the viewing directions 100, 102.

In a modification of the exemplary embodiment in FIGS. 8 and 9, which is described in greater detail with reference to FIG. 10, the encoded information is included in the lenticular array, which thus functions as an authenticating feature, while an imprint on the banknote forms the verification element.

FIG. 10 shows a banknote 116 having a security arrangement 110 according to the present invention and comprising an authenticating feature 112 applied over a window or hole 118 of the banknote in the form of a specially formed lenticular array and a verification element 114 in the form of an imprinted decoding area that is adapted to the lenticular array. The authenticating feature 112 is depicted in greater detail in FIG. 11(a), and the verification element 114 in FIG. 11(b).

In the exemplary embodiment, the authenticating feature 112 comprises an approximately 100 pm thick transparent PET foil into which a surface relief in the form of a lenticular array 120 is introduced. Here, the array elements 122 are formed by parallel straight cylinder lenses that exhibit, for example, a width of 50 μm and a spacing of 100 μm (grating period).

In a sub-area 124 of the lenticular array, the array elements 122 are offset by half a grating period, so 50 μm in the exemplary embodiment, compared with their position outside the sub-area 124. Here, the form of the sub-area 124 depicts the desired information, for example the denomination of the banknote, here the numeral “5”. The contour line shown in the figure merely serves the improved perceptibility of the sub-area 124 and is not present in a real lenticular array. Due to the small grating period, the offset of the sub-area 124 is hardly visible or is not visible at all under ordinary viewing conditions in transmitted or reflected light.

To read out the information of the authenticating feature 112, it is laid on the decoding area 126 of the verification element 114. The decoding area 126 includes, in printed form, a grid pattern 128 that corresponds to the grid pattern of the lenticular array 120, albeit without the information-bearing offset of the sub-area 124. Due to this coordination of the two grid patterns 128 and 122, the information included in the sub-area 124 stands out clearly when the lenticular array 120 is laid on the decoding area 126.

If the lenticular array 120 lies on the decoding area 126, then, due to the focusing effect of the cylinder lenses 122, the viewer sees in each case only a certain section of the printed decoding area 126. In a register-accurate arrangement of the lenticular array 120 and the decoding area 126, outside the sub-area 124, the viewer sees precisely the black print lines 128, while within the sub-area 124, he sees the white gap between adjacent print lines 128. The information, here the numeral “5”, thus appears white on a black background. When the authenticating feature 112 and the verification element 114 are shifted against each other by half a grating period, precisely the negative image impression results, in other words, a black piece of information on a white background.

As in the exemplary embodiment in FIGS. 8 and 9, a damage-free self-verification of a banknote 116 is not possible, since the authenticating feature 112 and the verification element 114 cannot be brought on top of one another in the correct orientation by rolling or folding the banknote.

In the exemplary embodiments described below with reference to FIGS. 12 to 14, the security arrangements each include two verification elements that must coact to check the authenticating feature. In this way, too, it can be ensured that only an external, but no self-verification of the banknotes can occur.

FIG. 12 shows a banknote 130 that is provided with a security arrangement 132 comprising an authenticating feature 134, a first verification element 136 and a second verification element 138.

The two verification elements 136 and 138 are disposed on the banknote at interpupillary distance and in the manner of stereoscopic glasses, for example red-green stereoscopic glasses or polarization stereoscopic glasses. Here, in the case of red-green stereoscopic glasses, the verification elements 136 and 138 consist of, for example, red and green filter foils embedded in the banknote paper.

In this case, the authenticating feature 134 disposed between the two verification elements 136, 138 includes an image motif that is printed on a light background with red and green ink. The two colored sub-images show the image motif from two different viewing angles such that, when the sub-images are conveyed to the eye by the corresponding filter foil, a vivid three-dimensional image effect is created for the viewer. The spatially depicted image motif, rendered in the figure only schematically as a cube, typically includes a feature that is characteristic for the banknote, such as its denomination.

Such a banknote 130 cannot now be brought, damage-free, into a position in which its authenticating feature 134 can be viewed through the two verification elements 136 and 138, but rather, a second homogeneous banknote is always required for the authenticity check. If all banknotes of a series are furnished with such security arrangements 132, only the authenticating features 134 differing depending on the denomination, then each banknote of the series can be used to check the authenticity of other banknotes of the series.

The two verification elements 136 and 138 can also form polarization stereoscopic glasses in that they are formed from two polarization foils oriented vertically to one another in a window area or hole in the banknote. In this case, the authenticating feature 134 disposed between the verification elements 136, 138 includes, coordinated with the polarization angle of the polarization foils, polarizing sub-images that can be imprinted, for example with the aid of inks that contain liquid crystal pigments.

FIG. 13 shows a further exemplary embodiment of the present invention, in which the two verification elements 146 and 148 of the security element 142 must be connected in series to be able to check the authenticating feature 144.

In the exemplary embodiment shown, the authenticating feature 144 consists of a liquid crystal layer that includes a characteristic motif that is introduced in a suitable manner. For example, the liquid crystal layer can include a first sub-area 152 that selectively reflects right-circularly polarized light, and a second sub-area 154 that, with the same color reflection spectrum, selectively reflects left-circularly polarized light. Under ordinary viewing conditions, the different circular polarization of the light reflected by the authenticating feature 144 cannot be perceived and the feature appears as a patternless color area.

In the exemplary embodiment, the first verification element 146 of the security arrangement 142 consists of a λ/4 layer that is adapted to the color reflection spectrum of the liquid crystal layer of the authenticating feature 144, and the second verification element 148 of a suitably oriented, linearly polarizing layer. To be able to perceive the encoded motif of the authenticating feature 144, the two verification elements 146 and 148 must be laid over the authenticating feature 144 in the right sequence, as described in greater detail below with reference to FIGS. 14(a) and 14(b).

The two verification elements 146 and 148 are disposed immediately next to one another on the banknote 140 such that they can be laid on one another by folding the banknote 140 about the centerline 150 of the two elements. The centerline 150 divides the authenticating feature 144 into two halves such that the laying of the two verification elements 146 and 148 on top of one another by folding the banknote simultaneously folds the authenticating feature 144 onto itself. In this way it is ensured that the authenticity check cannot be carried out with one banknote 140 alone since, when the verification elements are laid on top of one another correctly, the authenticating feature 144 is no longer available in the necessary form.

FIG. 14(a) shows a first variant of the authenticity check of a banknote 140-1 provided with the security arrangement 142-1. A second, homogeneous banknote 140-2 is folded such that its two verification elements 146-2 and 148-2 lie on top of one another in this sequence, and the folded banknote 140-2 is laid on the first banknote 140-1. For the sake of clarity, the two banknotes in the figure are depicted with a small spacing.

In its first sub-area 152, the authenticating feature 144 reflects selectively right-circularly polarized light, and in its second sub-area 154, selectively left-circularly polarized light. The λ/4 layer of the first verification element 146 converts this circularly polarized light into linearly polarized light with polarization directions that are vertical to one another. In the exemplary embodiment, the subsequent linear polarizing layer of the second verification element 148 is oriented such that it transmits the light originating from the second sub-area 154 and blocks the light originating from the first sub-area 152. The motif, in the exemplary embodiment the numeral “5”, then appears black against a light background.

The authenticity check can also be carried out with three homogeneous banknotes, as shown in FIG. 14(b). For this, unfolded second and third banknotes 140-2 and 140-3 are laid on the banknote 140-1 to be checked. The banknotes must be stacked such that the authenticating feature 144-1 of the first banknote 140-1, the first verification element 146-2 of the second banknote 140-2, and the second verification element 148-3 of the third banknote 140-3 lie on top of one another in this sequence. In this configuration, the information of the authenticating feature 144-1 can be read out as described above.

1. A security arrangement for one of a plurality of homogeneous security documents, having an authenticating feature that is characteristic for the security document and at least one verification element for checking the authenticating features of others of the plurality of homogeneous security documents, in which a damageless check of the authenticating feature of a security arrangement is practicable exclusively through a predefined combination effect with a verification element of a security arrangement disposed on another homogeneous security document.

2. The security arrangement according to claim 1, characterized in that a check of the authenticating feature of a security arrangement occurs in a predefined relative position of the authenticating feature and the verification element.

3. The security arrangement according to claim 2, characterized in that the authenticating feature and the verification element of the same security arrangement are geometrically so disposed to one another that they are not bringable into the predefined relative position on the security document without damage.

4. The security arrangement according to claim 2, characterized in that the authenticating feature and the verification element of the same security arrangement are coordinated with each other in such a way that, in the predefined relative position, the authenticating feature and the verification element of the same security arrangement do not display the predefined combination effect.

5. The security arrangement according to claim 2, characterized in that the predefined relative position is a stacking of the authenticating feature and the verification element with a certain spacing.

6. The security arrangement according to claim 1, characterized in that a check of the authenticating feature of a security arrangement occurs through a predefined relative movement of the authenticating feature and the verification element.

7. The security arrangement according to claim 6, characterized in that the authenticating feature and the verification element of the same security arrangement are geometrically so disposed to one another that the predefined movement with them is not executable without damage to the security document.

8. The security arrangement according to claim 6, characterized in that the authenticating feature and the verification element of the same security arrangement are coordinated with each other in such a way that the authenticating feature and the verification element of the same security arrangement do not display the predefined combination effect upon the predefined relative movement.

9. The security arrangement according to claim 1, characterized in that the authenticating feature and/or the verification element is formed to be transparent.

10. The security arrangement according to claim 1, characterized in that the authenticating feature and the verification element are disposed in or over a common window area or hole in the security document.

11. The security arrangement according to claim 1, characterized in that the authenticating feature and the verification element are disposed in immediate proximity to one another on the security document.

12. The security arrangement according to claim 1, characterized in that the verification element comprises an optical imaging element for examining the authenticating features of other security arrangements disposed on homogeneous security documents.

13. The security arrangement according to claim 12, characterized in that the optical imaging element constitutes a magnifying lens or a distortion lens.

14. The security arrangement according to claim 1, characterized in that the authenticating feature includes an area printed on with metameric inks, and the verification element comprises a filter element for viewing the metameric ink area of other security arrangements disposed on homogeneous security documents.

15. The security arrangement according to claim 1, characterized in that the authenticating feature comprises a first linearly polarizing window area, and the verification element a second linearly polarizing window area.

16. The security arrangement according to claim 1, characterized in that the authenticating feature comprises a first fine line pattern, and the verification element a second fine line pattern, the two line patterns producing interference effects when the authenticating feature and the verification element are stacked.

17. The security arrangement according to claim 1, characterized in that the authenticating feature and/or the verification element exhibit a diffraction effect, a lenticular array effect, a liquid crystal effect or a thin-film or multi-layer-film effect for checking the authenticating feature.

18. The security arrangement according to claim 1, characterized in that the security arrangement includes at least two verification elements for checking the authenticating features of others of the plurality of homogeneous security documents, a check of the authenticating feature occurring with the simultaneous use of two or more verification elements that are disposed on one or multiple of the plurality of homogeneous security documents.

19. The security arrangement according to claim 18, characterized in that two verification elements are disposed at interpupillary distance and are formed in the manner of stereoscopic glasses, the authenticating feature of a security arrangement evoking a three-dimensional image impression when viewed with both eyes through the two verification elements of a security arrangement applied on another security document.

20. The security arrangement according to claim 18, characterized in that, to check the authenticating feature of a security arrangement, two verification elements and the authenticating feature must be brought into the predefined sequence on top of one another.

21. The security arrangement according to claim 20, characterized in that the bringing on top of one another of the two verification elements of a security arrangement required for the check makes the authenticating feature of the same security arrangement inaccessible.

22. The security arrangement according to claim 1, characterized in that, in addition to the authenticating feature, also the verification element is formed characteristically for the security document such that a check of the authenticating feature is practicable only with such security arrangements whose verification element exhibits a characteristic design corresponding to the authenticating feature.

23. The security arrangement according to claim 1, characterized in that only the authenticating feature is formed characteristically for the security document, such that a check of the authenticating feature is practicable with any verification element of a security arrangement disposed on another homogeneous security document.

24. A security document, such as a security paper, value document or the like, having a security arrangement according to claim 1.

25. The security document according to claim 24, characterized in that the authenticating feature and the verification element are geometrically so disposed on the security document that they are not bringable into a predefined relative position required for the authenticity check without damage to the security document, or a predefined movement with them is not executable without damage to the security document.

26. The security document according to claim 24, characterized in that the authenticating feature and/or the verification element is disposed in or over a window area or hole in the security document.

27. The security document according to claim 24, characterized in that the security document is a security paper or a value document.

28. A method for manufacturing one of a plurality of homogeneous security documents, in which the security document is provided with a characteristic authenticating feature and at least one verification element for checking the authenticating features of others of the plurality of homogeneous security documents, a damageless check of the authenticating feature of a security arrangement being able to be carried out exclusively through a predefined combination effect with a verification element of a security arrangement disposed on another homogeneous security document.

29. The method according to claim 28, characterized in that, in addition to the authenticating feature, also the verification element is formed characteristically for the security document such that a check of the authenticating feature can be carried out only with such security arrangements whose verification element exhibits a characteristic design that matches the authenticating feature.

30. The method according to claim 28, characterized in that only the authenticating feature is formed characteristically for the security document, such that a check of the authenticating feature can be carried out with any verification element of a security arrangement disposed on another homogeneous security document.
